(19) United States
(12) Patent Application Publication
(10) Pub. No.: US 2004/0166281 A1
(43) Pub. Date: Aug. 26, 2004

(54) Multi-layered wet tissue product and manufacturing apparatus and method thereof

(75) Inventor: Han-Wook Park, Seoul (KR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignees: Adwin Korea Corporation, Seoul (KR); C&B Tech. Co., Ltd., Kyungki-Do (KR)

(21) Appl. No.: 10/412,481

(22) Filed: Apr. 11, 2003

(30) Foreign Application Priority Data
Feb. 21, 2003 (KR) 10-2003-0010941

(51) Int. Cl. B32B 5/18; B32B 3/00; B32B 31/14

(52) U.S. Cl. 428/72; 428/178; 428/198; 428/304.4; 156/77; 156/219; 156/290; 156/510; 156/580

(57) ABSTRACT

A multi-layered wet tissue product includes a first sheet layer embossed with a predetermined pattern and at a predetermined depth, and a second sheet layer embossed with a predetermined pattern and at a predetermined depth. The first and second sheet layers are thermally bonded to each other in a symmetrical structure such that an air layer can be formed between the first and second sheet layers and at least one of the first and second sheet layers is coated with liquid.

### BACKGROUND OF THE INVENTION

(a) Field of the Invention

The present invention relates to a multi-layered wet tissue product having the combination of softness, strength and absorbency while being made inexpensively.

The present invention further relates to manufacturing apparatus and method for making such a multi-layered wet tissue product.

(b) Description of the Related Art

Generally, wet tissue products are widely used and commercially offered in formats tailored for a variety of uses such as facial tissue products, toilet tissue products and absorbent towels.

Such wet tissue products are generally made of a spunlace non-woven fabric or an airlade non-woven fabric in which liquid with ingredients such as an antiseptic, a low stimulant vegetable material for protecting skin, vitamin E and the like is absorbed.

When the wet tissue product is used for babies, it can clearly remove foreign substances or other residue as if the baby skin is cleaned by water. However, a portion of moisture of the wet tissue product remains on the baby skin, resulting in the skin damage of the babies. Therefore, there is a need to remove the moisture from the baby skin using a dry towel and applying baby powder on the skin.

It is a troublesome for a user traveling with a baby to carry the dry towel and the baby powder together with the wet tissue product.

Furthermore, since the non-woven fabric used for the wet tissue product is generally formed to be very thin, the alien substance removed from the baby skin may be stained on the user's hand through a reverse side of the wet tissue product, causing an unpleasant feeling.

To prevent this, the user generally uses the wet tissue product in a state where plural plies of sheets are folded or piled up.

When the wet tissue product is formed of thick non-woven fabric to prevent the problem caused from a thin wet tissue product, the manufacturing cost is increased.

Meanwhile, since such wet tissue products are made of expensive spunlace non-woven fabric or an airlade non-woven fabric, the manufacturing cost is increased. Furthermore, such wet tissue products cause the environmental pollution in the course of the burn-up process.

### SUMMARY OF THE INVENTION

Therefore, the present invention has been made in an effort to solve the above-described problems.

It is a first objective of the present invention to provide a multi-layered wet tissue product that is enhanced in its softness, strength, and absorbency, while allowing the powdering on the skin.

It is a second objective of the present invention to provide apparatus and method for making such a multi-layer wet tissue product inexpensively.

To achieve the first objective, the present invention provides a multi-layered wet tissue product comprising a first sheet layer embossed at a predetermined pattern and a predetermined depth; and a second sheet layer embossed at the predetermined pattern and the predetermined depth, wherein the first and second sheet layers are thermally bonded to each other in a symmetrical structure such that an air layer can be formed between the first and second sheet layers; and at least one of the first and second sheet layers is coated with liquid.

Preferably, at least one of the first and second sheets is formed in two plies of sheets. The one ply of sheets may be an oil sheet.

The sheet layer where the liquid is coated may be further applied with a powder layer.

Preferably, specific advertising letters or labels may be printed on the sheets layers bonded.

To achieve the second objective, the present invention provides an apparatus for manufacturing a multi-layered wet tissue product, comprising an embossing roll for independently embossing first and second original sheets being continuously fed; a pressing roll for thermally-bonding the embossed first and second original sheets to provide a multi-layered sheet; a first coiler for rolling the multi-layered sheet to provide a primary multi-layered product; an uncoiler for releasing the primary multi-layered product and sending the released product to a next process; a liquid coating roll for coating liquid on the released primary multi-layered product; a powdering roll for applying powder on the primary multi-layered product coated with the liquid; a drier for drying the primary multi-layered product so that the product can contain a predetermined amount of liquid; a slitter for cutting the primary multi-layered product dried by the drier at a predetermined width; and a second coiler for rolling the primary multi-layered product cut at the predetermined width to provide a final multi-layered wet tissue product.

Preferably, the apparatus may further comprise a printing roll for printing specific advertising letters or labels, the printing roll being disposed between the pressing roll and the first coiler. The printing roll comprises a rotating shaft, and first and second roll shells mounted around the shaft, the first and second roll shells being provided at their outer surfaces with engraved plates corresponding to the letters and labels to be printed on the multi-layered sheet.

To still achieve the second objective, the present invention provides a method for manufacturing a multi-layered wet tissue product, comprising the steps of independently embossing first and second original sheets being continuously fed; thermally-bonding the embossed first and second original sheets to provide a multi-layered sheet; rolling the multi-layered sheet to provide a primary multi-layered product; releasing the primary multi-layered product and sending the released product to a next process; coating liquid on the released primary multi-layered product; applying powder on the primary multi-layered product coated with the liquid; drying the primary multi-layered product so that the product can contains a predetermined amount of liquid; cutting the primary multi-layered product dried by the drier at a predetermined width; and rolling the primary multi-layered product cut at the predetermined width to provide a final multi-layered wet tissue product.

The method may further comprise the step of printing letters or labels on the multi-layered sheet between the steps of bonding and pressing.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a sectional view of a multi-layered wet tissue product according to a first embodiment of the present invention;

FIG. 2 is a sectional view of a multi-layered wet tissue product according to a second embodiment of the present invention;

FIG. 3 is a sectional view of a multi-layered wet tissue product according to a third embodiment of the present invention;

FIG. 4 is a sectional view of a multi-layered wet tissue product according to a fourth embodiment of the present invention;

FIG. 5 is a sectional view of a multi-layered wet tissue product according to a fifth embodiment of the present invention;

FIG. 6 is a plan view of a multi-layered wet tissue product of the present invention;

FIG. 7 is a schematic view of a primary sheet processing part of a multi-layered wet tissue product manufacturing apparatus according to a preferred embodiment of the present invention;

FIG. 8 is an exploded perspective view of a printing roll for printing desired letters and labels;

FIG. 9 is a sectional view of an assembled printing roll;

FIG. 10 is a schematic view of a final sheet processing part of a multi-layered wet tissue product manufacturing apparatus according to a preferred embodiment of the present invention; and

FIG. 11 is a flowchart for illustrating a method for processing a multi-layered wet tissue product according to the present invention.

### DETAILED DESCRIPTION OF THE PREFERRED EMBODIMENTS

Preferred embodiments of the present invention will be described more in detail in conjunction with the accompanying drawings.

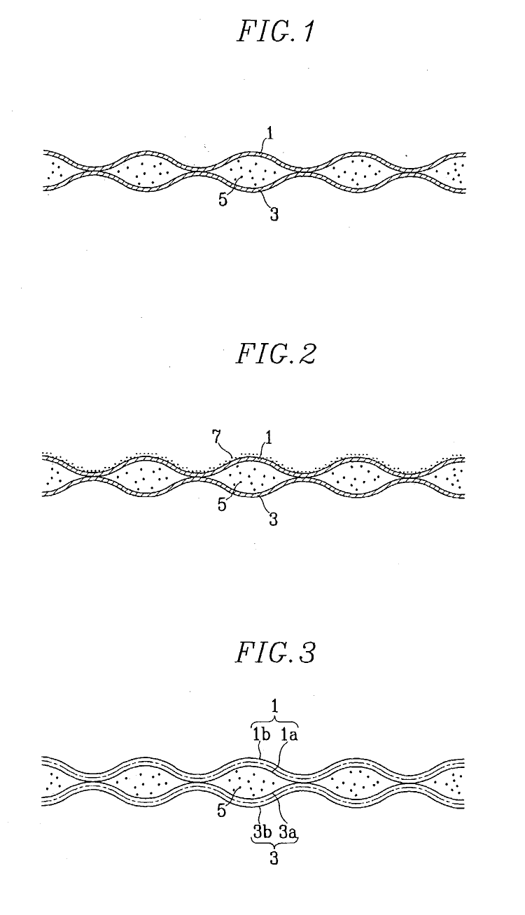

FIG. 1 shows a multi-layered wet tissue product according to a first embodiment of the present invention.

As shown in the drawing, a multi-layered wet tissue product comprises first and second sheet layers 1 and 3 moistened with liquid and an air layer 5 formed between the first and second sheet layers 1 and 3.

The first and second sheet layers 1 and 3 are preferably made of pulp that has been used for making the conventional dry tissue product to reduce the manufacturing cost when compared with the conventional wet tissue product that is made of costly spunlace non-woven fabric or airlade non-woven fabric. However, the sheet layers 1 and 3 may be made of, according to use, a variety of materials such as a non-woven fabric, textile, a PVC film, a PE film and a multi-plied sheet formed of the PE film and the pulp.

The first and second sheet layers 1 and 3 are embossed in a predetermined pattern and depth to improve the wiping property and increase the thickness of the tissue product. Accordingly, when one side of the tissue product wipes across skin, the removed alien substance can be prevented from coming out through the other side of the tissue product.

The fist and second sheet layers 1 and 3 each having an embossing structure and are overlapped with one another in a symmetrical structure, and then bonded through a thermal-bonding process, thereby completing a multi-layered sheet for a wet tissue product. Such a symmetrical overlapping structure is for forming the air layer 5 between the first and second sheet layers 1 and 3. The air layer 5 provides a cushion on the skin, allowing the soft wiping.

Since the air layer 5 makes the multi-layered sheet formed by the first and second sheet layers 1 and 3 thicker, the alien substance can be further prevented from coming out through the reverse side of the tissue product. Furthermore, when the tissue product wipes up the skin, the air layer 5 ejects air on the skin, removing the remaining moisture from the skin.

The air layer 5 makes it unnecessary to perform a series of processes for removing the moisture on the skin and drying the skin after cleaning the skin using the wet tissue product.

As shown in FIG. 2, the multi-layered wet tissue product may be further provided with a powder layer 7. The powder layer 7 is formed by applying powder on one of the first and second sheet layers 1 and 3. The powder is properly selected in accordance with the use of the tissue product.

Preferably, the powder layer 7 is formed on a skin-contacting surface of the tissue product moistened in water or other proper liquid. Therefore, when a user cleans the skin using the tissue product with the powder layer, the powder layer 7 allows the powder to be remained on the skin while absorbing the remaining moisture. Therefore, a special powdering process is not required. For example, when the user travels with his/her baby, there is no need of carrying separate baby powder.

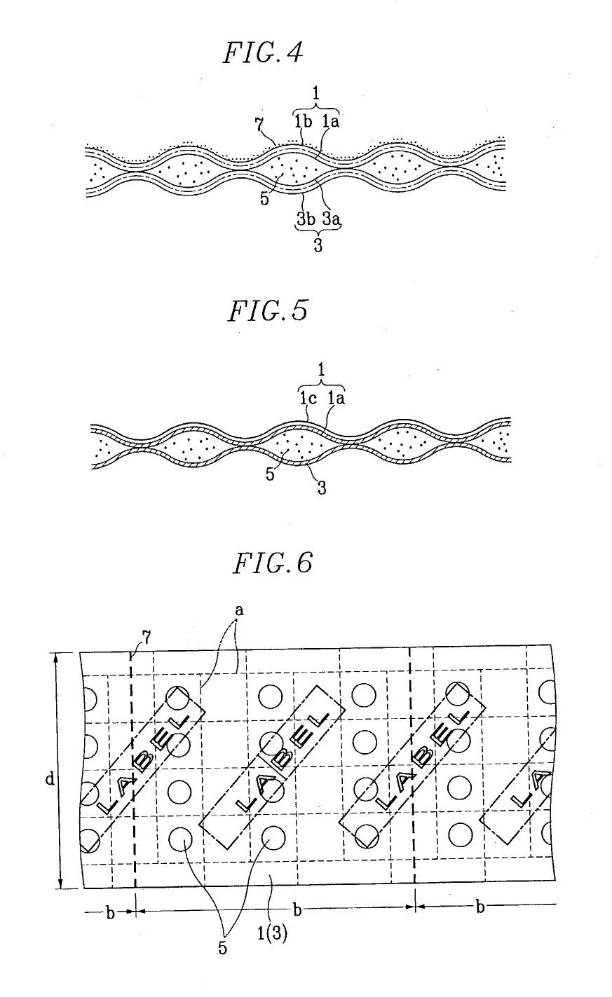

Meanwhile, each of the first and second sheet layers 1 and 3 may be formed of a single ply of sheet as shown in FIGS. 1 and 2, or at least one of them may be formed of two plies of sheet as shown in FIGS. 3 and 4. That is, the first and second sheet layers 1 and 3 have respectively inner and outer sheets 1a, 1b and 3a, 3b. When the first and second sheet layers 1 and 3 are formed in two sheets 1a, 1b and 3a and 3b, the thickness of the tissue product can be reduced when compared with the case where the wet tissue product is folded or piled up in twofold, while preventing the removed alien substance from coming-out through the reverse side of the tissue product. This two-ply sheet structure reduces the consumption of the wet tissue product.

In this case, the powder layer 7 is further applied on the outer sheet 1b of the first sheet layer 1 as shown in FIG. 4.

In addition, when one of the first and second sheet layers 1 and 3 is formed in the two-ply structure, one ply of sheets 1a and 1b can be replaced with an oil-sheet 1c.

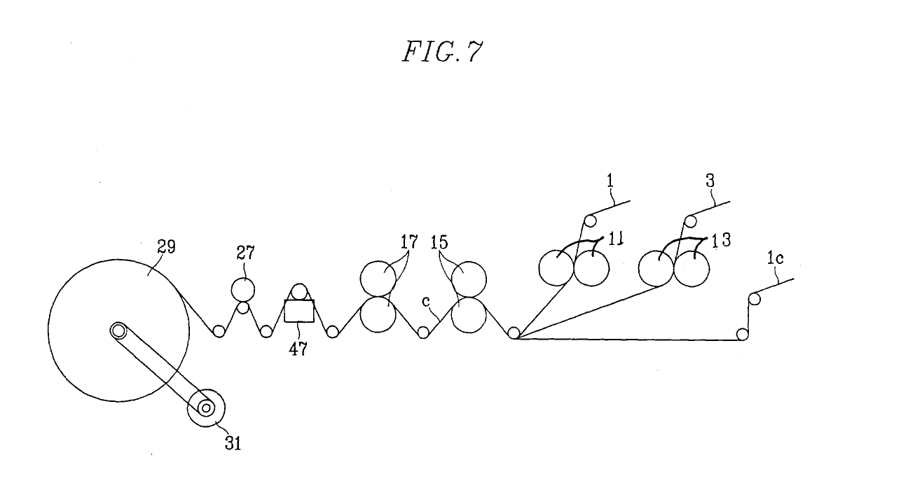

As shown in FIG. 6, the multi-layered wet tissue product shown in FIGS. 1 to 5 is designed to be used by being cut away along cutting lines 9 formed at a predetermined distance. That is, the first and second sheet layers 1 and 3 are continuously thermal-bonded in a symmetrical structure along a thermal-boding line a, and cutting lines are formed at the predetermined distance b so that a user can use the tissue product with a proper size.

In addition, advertising letters or labels representing, for example, the manufacturer, can be printed on the tissue product (in this embodiment, letters “LABELS” are printed as shown in FIG. 6).

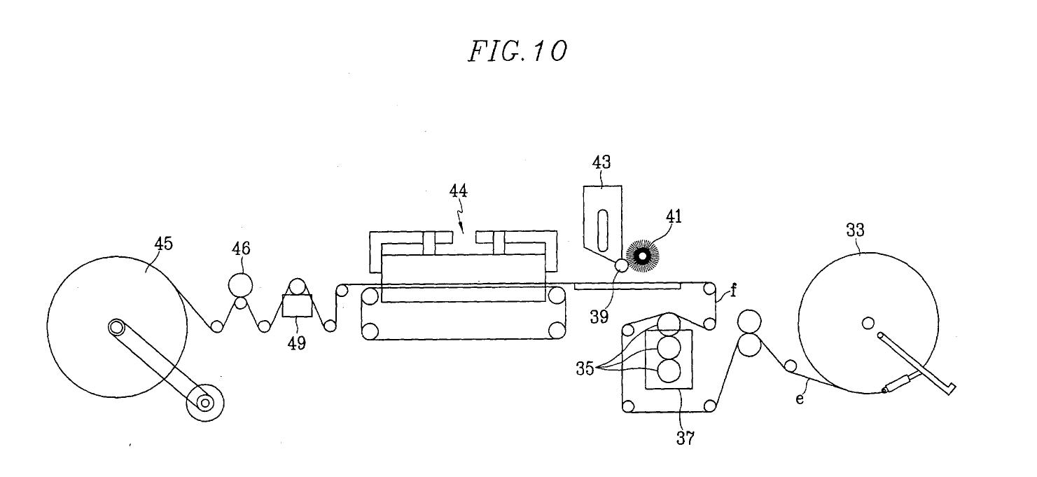

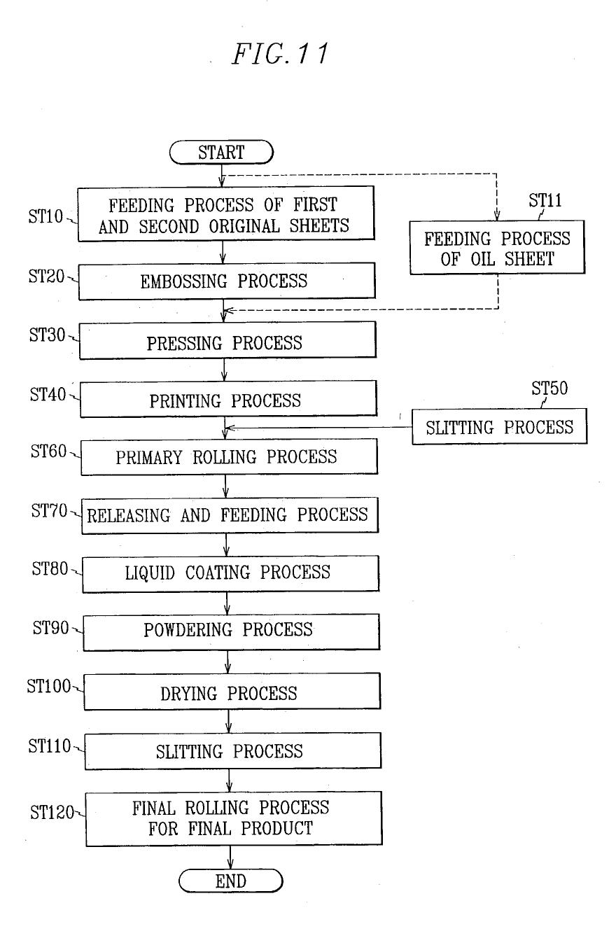

FIGS. 7 and 10 shows an apparatus for manufacturing the variety of above-described multi-layered wet tissue products of the present invention.

The manufacturing apparatus comprises embossing rolls 11 and 13 for respectively embossing the first and second sheet layers 1 and 3 that are continuously being fed. The number of embossing rolls corresponds to that of sheets being fed. A sheet such as the oil sheet 1c that is not required to go through the embossing process is bypassed without passing through the embossing rolls 11 and 13.

The first and second sheet layers 1 and 3 passed through the embossing rolls 11 and 13 are further advanced to the pressing roll 15. The pressing roll 15 is disposed downstream of the embossing rolls 11 and 13 to form a multi-layered sheet by thermal-bonding the first and second sheet layers 1 and 3 at the thermal-bonding portion “a.” By using the thermal-bonding process, the processing cost for making the multi-layered sheet can be saved.

The multi-layered sheet formed by the pressing roll 15 may selectively further pass through a printing roll 17 so that the letters or labels can be printed on the multi-layered sheet.

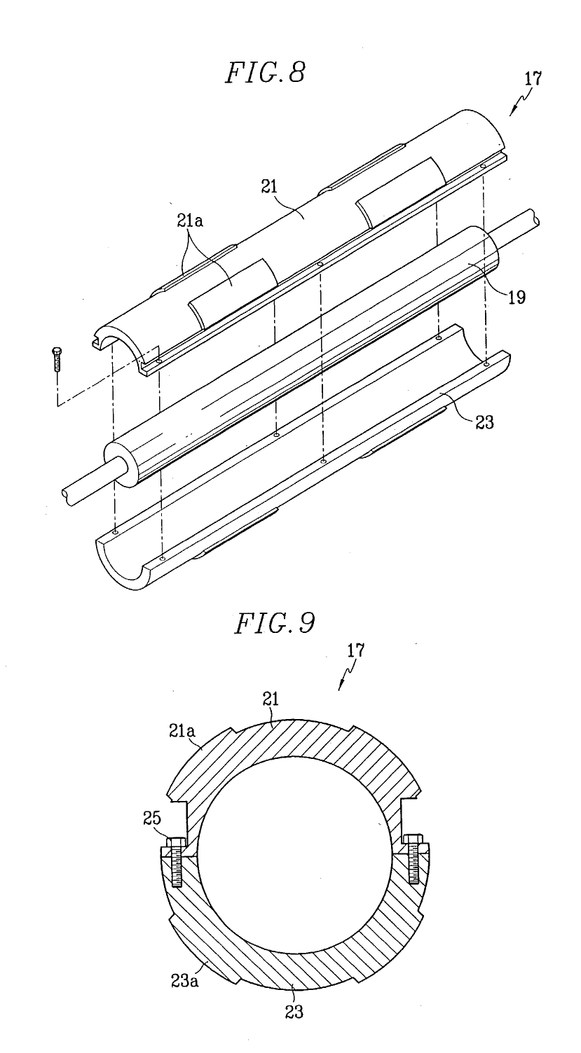

As shown in FIGS. 8 and 9, such a printing roll 17 comprises a rotating shaft 19, and first and second roll'shells 21 and 23. The rotating shaft 19 is driven by separated rotating means (not shown) to transmit power. The first and second roll shells 21 and 23 are semi-circular-shaped so that it can be mounted around the shaft 19 to integrally rotate therewith. The first and second roll shells 21 and 23 are provided at their outer surfaces with engraved plates 21a and 23a corresponding to the letters and labels to be printed on the multi-layered sheet. The first and second roll shells 21 and 23 are coupled to each other by a coupling member 25, thereby integrally rotating together with the shaft 19. The structure where the first and second roll shells 21 and 23 are assembled on the shaft 19 reduces the manufacturing costs of the printing roll 17, being proper to the production of multiple kinds and small quantity of tissue products.

The multi-layered sheet passed through the pressing roll 15 and/or printing roll 17 is further conveyed to a first slitter 27 or a first coiler 29.

The first slitter 27 is designed to cut the multi-layered sheet at a predetermined width b (see FIG. 6). The number of slitters 27 can be determined in accordance with a width of the multi-layered sheet to be fed thereto and a width of the final product.

The multi-layered sheet passed through the first slitter 27 is rolled by the first coiler 29, whereby a roll of primary products is completed. At this point, the slitter 27 is operated only when the roll of the primary product is the final product. That is, when the primary product is further processed into a wet tissue product, the first slitter 27 does not carry out the slitting operation.

The first coiler 29 is connected to rotating means by a power clutch 31. The power transmission of the rotating means is controlled by the power clutch 31, thereby controlling the multi-layered sheet winding operation of the first coiler 29.

The multi-layered sheet is further transferred to an uncoiler 33 shown in FIG. 10. The first coiler 29 and the uncoiler 33 may be omitted when the apparatuses shown in FIGS. 7 and 10 are formed as a single line. However, when the primary multi-layered sheet producing process and the final multi-layered sheet producing process are separated, it is preferable that that the coiler 29 and the uncoiler 33 are respectively provided.

The uncoiler 33 is designed to release the primary product rolled around the first coiler 29 to feed the same to the next process.

The primary product released by the uncoiler 33 is transferred to a liquid coating roll 35. The liquid coating roll 35 has a multiply structure rotating and contacting a liquid tank containing liquid such as water and oil to be coated on the primary sheet. Such a multiply structure allows the liquid to be coated on a surface of the primary product little by little.

The primary product “f” passed through the liquid coating roll 35 is further transferred to a powder roll 39 and a brush 41. As the powder roll 39 disposed under the powder tank 43 rotates, the powder is ejected little by little. At this point, as the brush 41 brushes the powder roll 39, the powder attached on the powder roll 39 is detached therefrom and applied on the surface of the primary product “f” where the liquid is coated. When the final product is for the makeup tissue product, since the oil is coated on the primary product “e,” it is preferable that the operation of the powder roll is stopped.

The primary product “f” is further advanced to a dryer 44 where over-coated liquid on the primary product is dried.

Then, the primary product “f” is further transferred to a second slitter 46 where the product “f” is cut at a predetermined width “b” (see FIG. 6). The number of the slitters 46 is determined in accordance with a width of the product “f” and a width of the final product.

The product “f” is further fed to a second coiler 45 having the identical structure to that of the first coiler 29. The product “f” is rolled by the coiler 45, whereby a roll of final multi-layered wet tissue product is completed.

Meanwhile, load sensors 47 and 49 are respectively provided between the printing roll 17 and the first slitter 27 and between the dryer 43 and the second coiler 45. The load sensors 47 and 49 are provided to control the transferring speed and tension of the sheets being fed.

FIG. 11 shows a method for manufacturing the above-described multi-layered wet tissue product.

The first and second original sheets are continuously initially fed (ST10). When the tissue product is for the makeup use, a third sheet to be the oil sheet 1c is further fed together with the first and second original sheets.

The first and second original sheets 1 and 3 are independently embossed (ST20), and then the embossed sheets are bonded to each other in a symmetrical structure through a pressing process ST30, thereby providing a multi-layered product “c” having the first and second sheet layers 1 and 3 between which an air layer 5 is formed.

After the pressing process ST30, a printing process ST40 can be performed or a slitting process ST50 may be performed by skipping the printing process ST40.

That is, the printing process ST40 is selectively performed to print specific letters or labels on the multi-layered product “c.”

In the slitting process ST50, the multi-layered product “c” is cut at a predetermined width “b,” whereby a primary multi-layered product “e” is completed. The slitting process ST 50 is performed when the primary multi-layered product “e” is the final product, but is bypassed when the primary multi-layered product should be further processed in a multi-layered wet tissue product.

The primary multi-layered product “e” is sent to a first winding process ST60 where the primary product “e” is rolled. Then, the primary multi-layered product “e” rolled in the first winding process ST60 is released (ST70) and fed to the liquid coating process ST80 where liquid such as water and oil is coated on the primary multi-layered product “e.” That is, when the final produce is for a baby tissue product, purified water is coated, and when for a makeup tissue product, oil is coated.

Next, the multi-layered product “f” is transferred to a powder application process ST90 where powder such as baby powder and makeup powder is applied on the liquid coated surface of the multi-layered product “f.” The powder is not applied on the product “f” where the oil is coated.

After the above, the product “f” is transferred to a dry process ST100 where the product “f” is dried so that it can contain a predetermined amount of moisture. That is, in this dry process ST100, over-coated moisture is dried so that the product can maintain only a predetermined amount of moisture.

Then, the product “f” is transferred to a slitting process ST110 where the product “f” is cut at a predetermined width, after which a secondary winding process ST120 for finally rolling the product “f” is carried out, thereby completing the multi-layered wet tissue product.

As described above, since the wet tissue product is formed of plural layers between which air is formed and applied with powder, it can provides a variety of advantages such as its portability, improved skin cleaning ability, and the like, while reducing the consumption amount thereof.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A multi-layered wet tissue product comprising:
a first sheet layer embossed with a predetermined pattern at a predetermined depth; and
a second sheet layer embossed with a predetermined pattern at a predetermined depth,
wherein the first and second sheet layers are thermally bonded to each other in a symmetrical structure such that an air layer can be formed between the first and second sheet layers; and
at least one of the first and second sheet layers is coated with liquid.

2. A multi-layered wet tissue product of claim 1 wherein at least one of the first and second sheets is formed in the two-ply sheet.

3. A multi-layered wet tissue product of claim 2 wherein one ply of the two-ply sheet is an oil sheet.

4. A multi-layered wet tissue product of claim 1 wherein the sheet layer where the liquid is coated is further applied with a powder layer.

5. A multi-layered wet tissue product of claim 1 wherein specific advertising letters or labels are printed on the sheets layers bonded.

6. An apparatus for manufacturing a multi-layered wet tissue product, comprising:
an embossing roll for independently embossing first and second original sheets being continuously fed;
a pressing roll for thermally-bonding the embossed first and second original sheets to provided a multi-layered sheet;
a first coiler for rolling the multi-layered sheet to provide a primary multi-layered product;
an uncoiler for releasing the primary multi-layered product and sending the released product to a next process;
a liquid coating roll for coating liquid on the released primary multi-layered product;
a powdering roll for applying powder on the primary multi-layered product coated with the liquid;
a drier for drying the primary multi-layered product so that the product can contains a predetermined amount of liquid;
a slitter for cutting the primary multi-layered product dried by the drier at a predetermined width; and
a second coiler for rolling the primary multi-layered product cut at the predetermined width to provide a final multi-layered wet tissue product.

7. An apparatus of claim 6 further comprising a printing roll for printing specific advertising letters or labels, the printing roll being disposed between the pressing roll and the first coiler.

8. An apparatus of claim 7 wherein the printing roll comprises a rotating shaft, and first and second roll shells mounted around the shaft, the first and second roll shells being provided at their outer surfaces with engraved plates corresponding to the letters and labels to be printed on the multi-layered sheet.

9. A method for manufacturing a multi-layered wet tissue product, comprising the steps of:
independently embossing first and second original sheets being continuously fed;
thermally-bonding the embossed first and second original sheets to provided a multi-layered sheet;
rolling the multi-layered sheet to provide a primary multi-layered product;
releasing the primary multi-layered product and sending the released product to a next process;
coating liquid on the released primary multi-layered product;
applying powder on the primary multi-layered product coated with the liquid;
drying the primary multi-layered product so that the product can contains a predetermined amount of liquid;
cutting the primary multi-layered product dried by the drier at a predetermined width; and
rolling the primary multi-layered product cut at the predetermined width to provide a final multi-layered wet tissue product.

10. A method of claim 9 further comprising the step of printing letters or labels on the multi-layered sheet between the steps of bonding and pressing.

11. A wet tissue product comprising:
a sheet layer in which liquid is absorbed, the sheet layer being formed in one or more sheets; and
a powder layer formed on a side of the sheet layer.

12. A wet tissue product of claim 11 wherein when the sheet layer is formed in at least two sheets, the sheets are bonded such that an air layer is formed therebetween.

13. A wet tissue product of claim 10 wherein the liquid is selected from the group consisting of water and or oil.

14. A wet tissue product of claim 13 wherein the air layer is formed by independently embossing the sheets at a predetermined pattern with a predetermined depth and thermally bonding the sheets in a symmetrical structure.
